(19) United States
(12) Patent Application Publication
(10) Pub. No.: US 2025/0022129 A1
(43) Pub. Date: Jan. 16, 2025

(54) SYSTEM TO ASSIST FARMERS

(71) Applicant: UNIVERSITY OF NORTH TEXAS, Dallas, TX (US)

(72) Inventors: Saraju P. MOHANTY, Dallas, TX (US); Elias KOUGIANOS, Dallas, TX (US); Alakananda MITRA, Dallas, TX (US)

(21) Appl. No.: 18/755,561

(22) Filed: Jun. 26, 2024

Related U.S. Application Data
(60) Provisional application No. 63/510,881, filed on Jun. 28, 2023.

(51) Int. Cl. G06T 7/00; A01G 7/00; G06T 7/62; G06V 10/764; G06V 10/77; G06V 20/10; G06V 20/17

(52) U.S. Cl. CPC G06T 7/0012; A01G 7/00; G06T 7/62; G06V 10/764; G06V 10/7715; G06V 20/188; G06T 2207/10032; G06T 2207/20081; G06T 2207/30188; G06V 20/17

(57) ABSTRACT

Disclosed aspects relate to systems and methods for assisting farmers with crop management. For example, systems may be configured to estimate crop damage, identify plant disease, estimate plant disease severity, and/or identify weeds. In some aspects, automated systems may process images of an area having crops, for example using one or more crop model. The models may identify one or more property of the crop, which can be used to better manage crops.

### CROSS-REFERENCE TO RELATED APPLICATIONS

This application claims the benefit of U.S. Provisional Patent Application No. 63/510,881, filed Jun. 28, 2023, the entire contents of which are incorporated herein by reference.

### STATEMENT REGARDING FEDERALLY SPONSORED RESEARCH OR DEVELOPMENT

Not applicable.

### FIELD

This disclosure relates generally to agriculture. More particularly, this disclosure relates to systems and related methods for assisting farmers in addressing issues with crops.

### BACKGROUND

The world's population is projected to reach 9.7 billion by 2050 and 11 billion by the end of this century. Based on these forecasts, it is projected that global food consumption will expand rapidly. The required increase in food production to feed the growing population is a monumental undertaking. Increasing food supply output is only achievable with smart and sustainable agriculture. However, there are several issues that affect food production. These issues affect the quality of the crop and reduce the final yield and eventually can cause huge financial loss. Systems are needed to assist farmers in addressing issues, in hopes of increasing food production.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts. These drawings illustrate certain aspects of some examples of the present disclosure and should not be used to limit or define the disclosure.

FIG. 1A is a schematic illustration of an exemplary system, comprising a plurality of systems and/or subsystems, according to an embodiment of the disclosure.

FIG. 1B is a schematic illustration of an exemplary system of the sort that could be used as one of the plurality of systems and/or subsystems in FIG. 1A, according to an embodiment of the disclosure.

FIG. 2 is a schematic illustration of an exemplary architecture of the system of FIG. 1A, according to an embodiment of the disclosure.

FIG. 3A is a schematic illustration of an exemplary system for crop management, according to an embodiment of the disclosure.

FIG. 3B is a schematic illustration of a system similar to FIG. 3A, illustrated in further detail, according to an embodiment of the disclosure.

FIGS. 3C-3D are schematic illustrations of procedures for training a model, according to an embodiment of the disclosure.

FIG. 4 is a schematic illustration of an exemplary crop damage estimation system, according to an embodiment of the disclosure.

FIG. 5A is a schematic illustration of an exemplary method for grid generation, according to an embodiment of the disclosure.

FIG. 5B is a schematic illustration of an exemplary snapshot method, according to an embodiment of the system.

FIG. 6 is a schematic illustration of an exemplary grid generated on a crop filed, according to an embodiment of the disclosure.

FIG. 7A is a schematic illustration of an exemplary developmental workflow of damage detection method, according to an embodiment of the disclosure.

FIG. 7B is a schematic illustration of an exemplary damage detection method, according to an embodiment of the disclosure.

FIG. 8 is a schematic illustration of an exemplary crop damage estimation process, according to an embodiment of the disclosure;

FIG. 9 is a schematic illustration of an exemplary plant disease identification system, according to an embodiment of the disclosure.

FIG. 10 is a schematic illustration of an exemplary developmental workflow for an exemplary plant disease identification system, according to an embodiment of the disclosure.

FIG. 11 is a schematic illustration of an exemplary plant disease identification system process, according to an embodiment of the disclosure.

FIG. 12 is a schematic illustration of an exemplary disease severity estimation process, according to an embodiment of the disclosure.

FIGS. 13A-13C is a schematic illustration of an exemplary leaf area detection process, according to an embodiment of the disclosure.

FIGS. 14A-14B is a schematic illustration of an exemplary damage area detection process, according to an embodiment of the disclosure.

FIG. 15 is a schematic illustration of an exemplary automatic verification of disease severity process, according to an embodiment of the disclosure.

FIG. 16 is a schematic illustration of an exemplary weed identification process, according to an embodiment of the disclosure.

FIG. 17 is a schematic illustration of an exemplary developmental workflow for an exemplary weed identification system, according to an embodiment of the disclosure.

FIG. 18 is a schematic illustration of formulation of an exemplary target bounding box, according to an embodiment of the disclosure.

FIG. 19A is a schematic illustration of an exemplary system, according to an embodiment of the disclosure.

FIG. 19B is a schematic illustration of exemplary modules of an edge node, according to an embodiment of the disclosure.

FIG. 19C is a schematic illustration of an exemplary model training method, according to an embodiment of the disclosure.

FIG. 20 is a schematic illustration of an exemplary workflow of model training, according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The description that follows includes example systems, methods, techniques, and program flows that embody aspects of the disclosure. However, it is understood that this disclosure may be practiced without these specific details. For brevity, well-known steps, protocols, structures, and techniques have not been shown in detail in order not to obfuscate the description. The disclosure should in no way be limited to the illustrative implementations, drawings, and techniques illustrated below, but may be modified within the scope of the appended claims along with their full scope of equivalents.

There are several possible issues which can negatively impact crop production. Some of the issues may be human contributed and can only be prevented through changes in society as a whole and in lifestyle. For example, urbanization can alter dietary practices. For example, urbanization has typically increased consumption of animal protein. There may be a diminishing of natural resources. For example, agricultural grounds can become unfit for agriculture. Sources indicated that 25% of the existing agricultural land is severely inappropriate, while 44% is moderately unfit, and that water scarcity has rendered 40% of the agricultural land unusable. Deforestation for urban growth and new farming can deplete groundwater. Over farming can result in short fallow times, a lack of crop rotation, and overgrazing by livestock, which can cause soil erosion. Further, climate change can affect every area of agricultural production. For example, in the past fifty years, greenhouse gas emissions have doubled, resulting in erratic precipitation and an increase in droughts and floods. Food wastage is another contributing factor. According to sources, 33% to 50% of the food produced is wasted across the globe.

However, there are issues that can be prevented. For example, stunted growth of the plants and plant/crop damage can cause yield reduction and eventually financial loss. The causes of plant/crop damage and stunted plant growth can include, but are not limited to, plant diseases, weed and pest infestation, and/or environmental factors e.g., soil nutrients, soil moisturizer, temperature, air pressure, and availability of optimum sunlight.

Some issues may be unavoidable by human action. Examples may include natural calamities, e.g., drought, hail, storm, flood, and freeze. These issues may have multifold effects such as plant disease causing slower growth or no growth of the plants, and/or plant disease damaging the plant. If the plant gets infected with disease during crop production, crop damage occurs. Wrong identification of disease leads to wrong control measures which in turn can affect the growth and yield. Lack of knowledge on disease severity can also lead to misuse of pesticides. Weed infestation is another factor stalling plant growth as is pest infestation damages plants/crops. If the crop growth is affected, it in turn the crop yield can be reduced. Natural causes like drought, hail, storm, flood, and freeze can also damage plants and crops that cost farmers substantial financial losses. Environmental factors e.g., soil nutrients, soil moisturizer, temperature, air pressure, and availability of optimum sunlight always affect the growth of the plants. When the plant growth is stunted and plants/crops are damaged, crop yield is typically reduced. Crop yield reduction and crop damage or crop loss both contribute to huge economic loss to the farmers.

Current attempts to solve such issues have proven limited in application and effect. For example, with the existing frameworks and infrastructure, it is not easy to implement solutions for different issues globally, with scalability to different size farms proving difficult. Disclosed embodiments may use a unified Agricultural systems of systems (A-SsoS) that can assist farmers to take necessary steps against one or more crop issue. Some embodiments may amalgamate various technologies to provide better and advanced solutions to various agriculture issues. Disclosed embodiments may be directed to provide solutions to root causes/issues of plants/crops damage and stunted growth to improve crop growth and crop yield.

One or more of the following issues may be solved by the disclosed embodiments: (1) problem of Crop Damage Estimation Caused by Natural Events-Natural causes like drought, hail, storm, flood, and freeze can also damage plants and crops that cost farmers substantial financial losses. Farmers file may insurance claims to avert such losses. However, the process can be time consuming, tedious, and the possibility of error may be high because it is done manually. Extrapolation and manual identification of Homogeneous Damage Zones (HDZs) can result in errors. Large lands can have diverse dams. Extrapolation can fail. As insurance money relieves farmers' stress, the claim process must be easy, seamless, and accurate. Disclosed embodiments may address this problem. (2) Problem of Plant Disease Identification-If the plant gets infected with disease during crop production, crop damage occurs. Wrong identification of disease leads to wrong control measures which in turn affects the growth and yield. Plant disease detection can also be part of disclosed embodiments (e.g. SsoS). (3) Problem of Plant Disease Severity Estimation-Without knowing the disease severity, wrong measures may be taken. The wrong amount of pesticides can be used, which in turn can cause secondary damage. (4) Problem of Weed Detection and Effect on Crop Growth—As weed affects agricultural yield, spraying herbicides over the whole farmland has become a common practice. However, it causes water and soil pollution, as unnecessary amounts of pesticides are sprayed. Disclosed embodiments can address weed detection. (5) Problem of not having a unified system to consolidate several agricultural problems in one system. (6) Problem of not having an internet of things (IoT)-edge computing system for the solution. (7) Problem of not considering the secondary damage and pollution in using pesticides and herbicides. (8) Problem of not having a totally automatic system which only needs the image(s) of the concerned object. (9) Problem of not having a system which can also predict the pesticide/herbicide amount depending on the damage/weed severity.

To address one or more of these problems/issues, disclosed embodiments may include one or more of the following features: The agricultural systems of systems (A-SsoS) can be a unified application suite, can be automated, can aim to provide solutions to various issues farmers face, can address agricultural issues caused by preventable and unavoidable causes, can be edge friendly, can require less user intervention, can have high accuracy (e.g. relative to pre-existing approaches), can give real time predictions, and/or can be scalable depending on the area of the land.

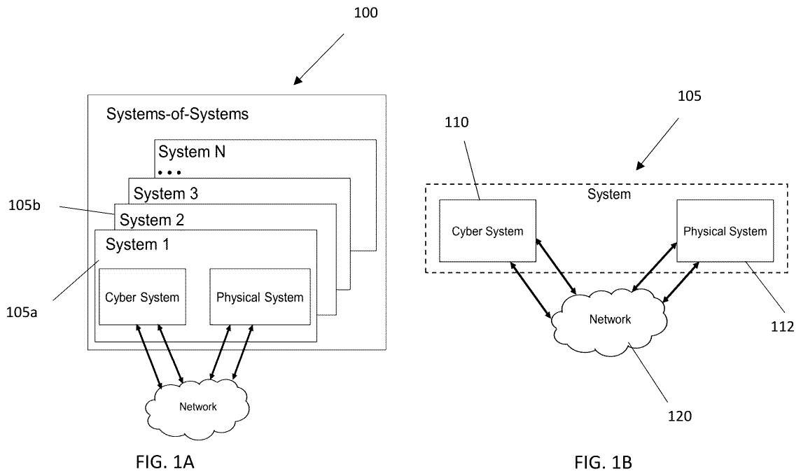

Disclosed embodiments may include a system of systems (SsoS) framework built from integration of several systems (e.g. computation and physical elements) in a consistent and reliable manner. The high-level architectural view of an exemplary system is shown in FIG. 1 and is discussed in detail below. The A-SsoS can be deployed in cloud and edge environments. For example, there can be localized edge servers (e.g., internet of autonomous things (IoAT) Edge Server), that can be connected to the cloud through the Internet. Edge servers can be connected to the end devices through IoAT Gateway, and may be configured to process data coming from various “things” and send results to the user. In embodiments, the system can operate offline. For example, the system may send the results and data to the cloud for storage purposes only. If in future those data are needed, the data can be retrieved from cloud storage. Artificial Intelligence (AI) and Machine Learning (ML) models of the systems can be built based on publicly available data. Privacy of the data can be been maintained, for example with the use of blockchain at the edge. AI/ML solution at the edge can make the entire process automated and highly accurate. Use of graphical processing units (GPUs) can strengthen the edge server.

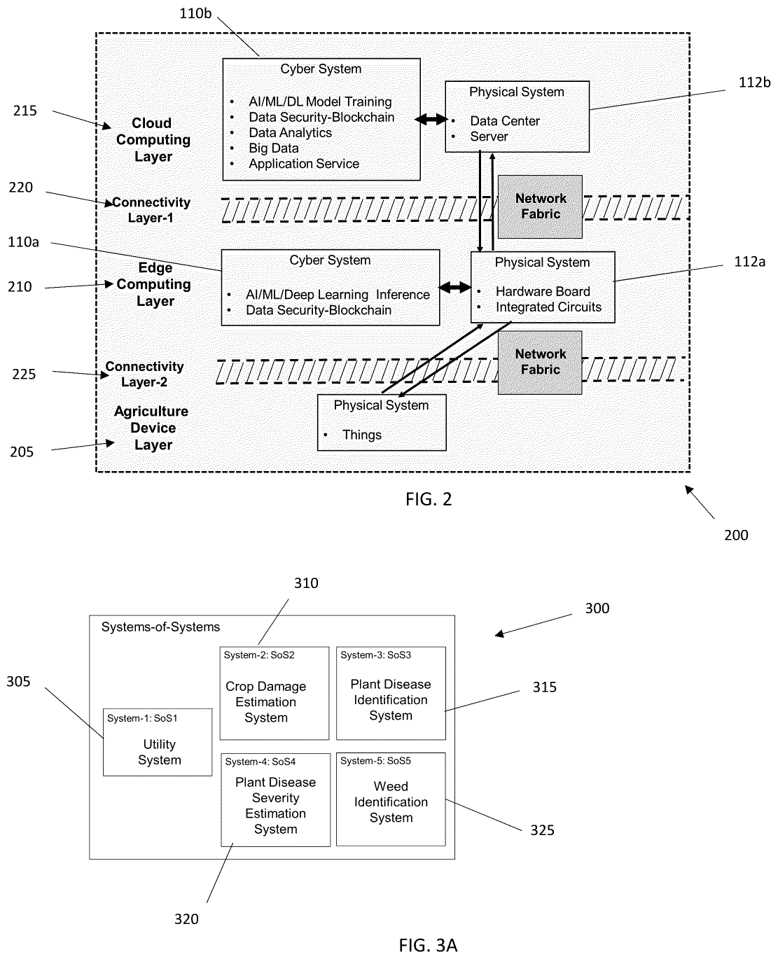

Disclosed system embodiments can include a group of independent systems, combined into a larger system (Systems of Systems) 100 as in FIG. 1A, that serves unique actions. Each system 105 as shown in FIG. 1B can have a cyber part 110 and physical part 112, which can be connected through network 120 fabric. Each system can be distributed over a 3-layer architecture 200 as in FIG. 2. Two additional connectivity layers can bridge these 3 layers. For example, the architecture can begin with the agriculture device layer 205. It can consist of various physical systems a wide range of tools and technologies, such as sensors dispersed around the farmland, animal enclosures, greenhouses, hydroponic systems, tagged animals, unmanned aerial vehicles (UAVs) (which may include a camera), agricultural robots, automated fencing, tractors, and smart phone cameras. For example, in some embodiments UAVs (such as drones) and/or smart phone cameras may be used.

The second layer 210 can include the edge computing layer. Cyber systems 110a and physical systems 112a may comprise this layer. Various hardware boards and integrated circuits can form the physical systems in this layer. In this layer, AI/ML/DL Inference processes and edge based Blockchain can form the cyber system.

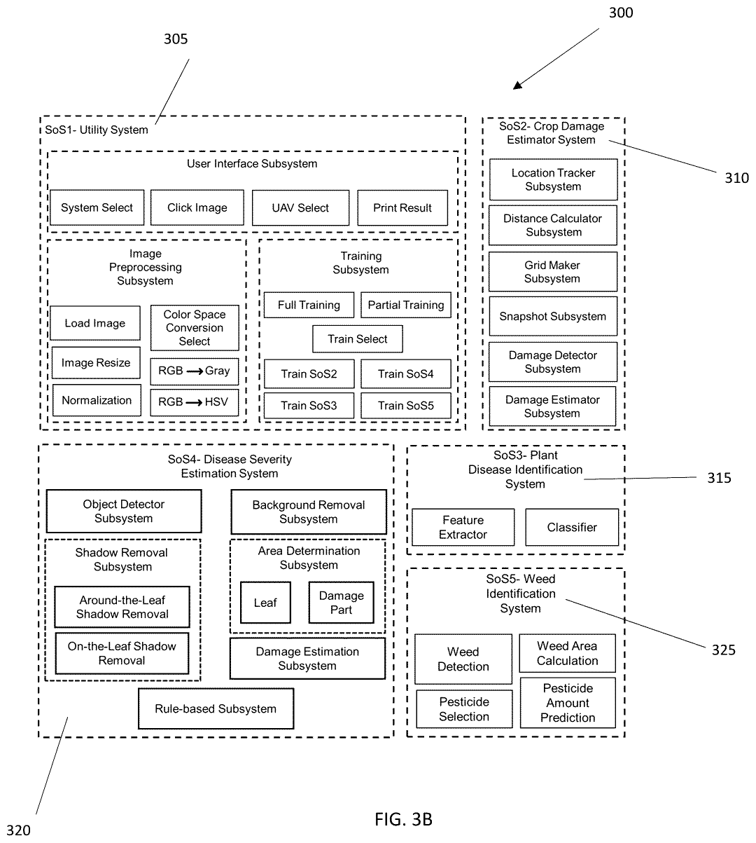

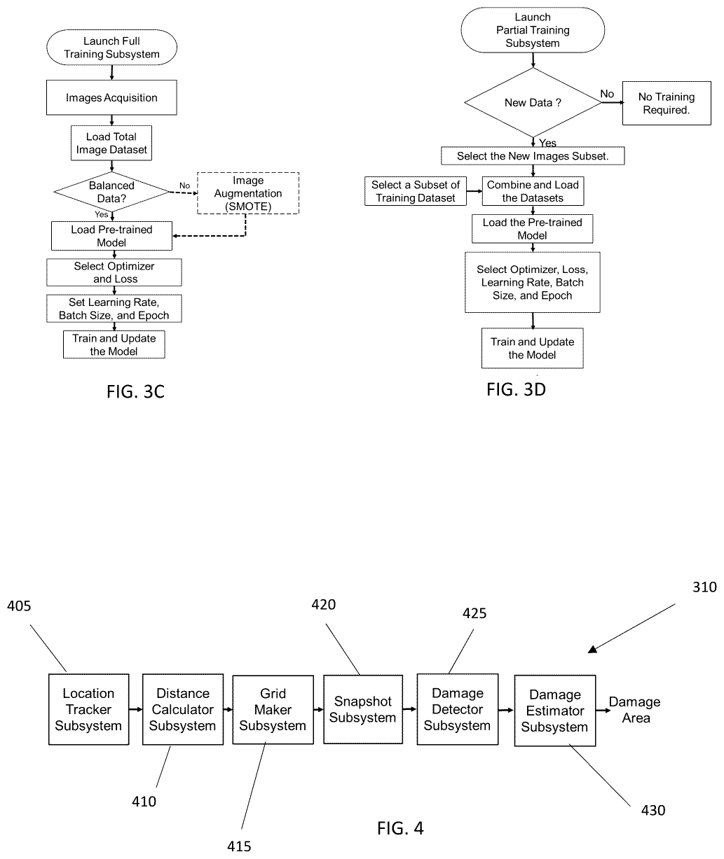

The topmost layer 215 can be the cloud computing layer. AI/ML/DL model training, distributed ledger, application services, and data analysis services can comprise the cyber system 110b here. Data centers and servers can technically comprise the physical system 112b. Connectivity layer 1 220 and layer 2 225 can be the network fabrics. For layer 1, the internet may be used, and for layer 2 LoRaWAN may be used as the network fabrics in some embodiments. Stakeholders like farmers, plant pathologists, environmental scientists, horticulturists, insurance providers can access solutions through system APIs. FIG. 3A illustrates exemplary component systems of the system of systems 300. Each system can be configured to address a specific agricultural issue. Each system can include of a group of systems which may be defined through various sub-systems. There may be certain systems which are common to the other systems. A modular approach can make the problem simpler to update, reuse their components, and/or easily add more functionalities. They also can reduce the memory overhead when multiple applications use the same feature simultaneously. FIG. 3B illustrates the details of exemplary higher-level architecture of the SsoS 300.

As shown in FIG. 3A, system 300 can include a utility system 305, a crop damage estimation system 310, a plant disease identification system 315, a plant disease severity estimation system 320, and/or a weed identification system 325. For example, the first system can be the utility system 305, which in the embodiment of FIG. 3b may include 3 subsystems such as a User Interface Subsystem (UIS), an Image Pre-processing Subsystem (IPS), a Training Subsystem (TS), or any combination thereof.

The UIS can be the interface of the user and the system, e.g. the A-SsoS. System select can allow the user to select among the systems. UIS also can allow the user to take images through click image. UAV select can allows the user to use a UAV for taking photos. Finally, print result can display the result.

The next subsystem of SoS1-Utility system can be the IPS. Image resizing, normalization, and color space conversion may be done through this subsystem. Color space conversion select can allow the flag to set two values 0 and 1. For example, 1 value selects RGB→Gray conversion and 0 selects RGB→HSV conversion. SoS2, SoS3, and SoS5 can use the flag value of 1 whereas SoS4 uses flag value 0.

The next subsystem of Utility system can be TS. Provision of full and partial training of all the systems may be provided. FIGS. 3C and 3D illustrate an exemplary full and partial training process respectively. TS can choose the system to train. The values of the systems can be 010, 011, 100, and 101 for systems SoS2, SoS3, SoS4, and SoS5 respectively. The specific training parameters can be chosen from Train SoS2, Train SoS3, Train SoS4, and Train SoS5.

Disclosed embodiments can also include a crop damage estimation system 310, which may be the second system in FIG. 3A. For example, a method for estimating the extent of crop damage can be provided that includes the training system. FIG. 4 shows exemplary high-level structure of an illustrative SoS2-crop damage estimation system 310. It can be one of the systems in the proposed systems of systems, and can include different subsystems. For example, the subsystems can include a Location Tracker Subsystem (LTS), a Distance Calculator Subsystem (DCS), a Grid Maker Subsystem (GMS), a Snapshot Subsystem (SSS), a Damage Detector Subsystem (DDS), and/or a Damage Estimator Subsystem.

The location tracker system 405 can retrieve the position of the four corners of the land at issue, for example in terms of latitude and longitude in radian. It can be installed in the UAV that takes photos and notes the locations. The distance calculator system 410 can calculate the distance between every two consecutive points of the above four points and draw a rectangle from the four points using an algorithm such as Algorithm 1 (see below). In some aspects, instead of Euclidean distance, the great circle distance between two points of a sphere can be calculated using Haversine formula.

### Algorithm 1: Procedure to Calculate a Side Length of the Grid

1. Function distCal ((ϕ₁, λ₁), (ϕ₂, λ₂)):
2. Declare θ₁ and θ₂.
3. Set

$${θ}_{1} ← ( \frac{{ϕ}_{1} - {ϕ}_{2}}{2} ) and {θ}_{2} ← ( \frac{{λ}_{1} - {λ}_{2}}{2} ) .$$

4. Declare the Earth's Radius R and initialize to 6371×10³.
5. Calculate 2Rarcsin (sin²θ₁+cos (ϕ₁)·cos (ϕ₂)·sin²θ₂)^{1/2}
6. Set the calculated distance value to D.
7. return D

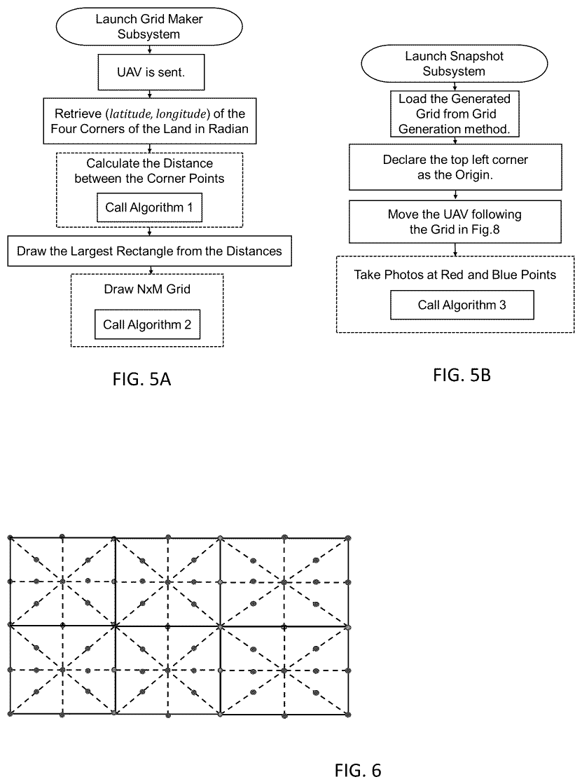

The GMS can be used to determine a grid. Here at 415, the grid can be formed, for example using the grid generation method in FIG. 5A. The length and width of the rectangle can be divided (e.g., by a factor of 10-1000, or about 100) and a (N×M) smaller squares can be generated forming a N×M grid as mentioned in Algorithm 2 (see below).

### Algorithm 2: Procedure to Draw the Squares in the Grid

1. Function gridMaker (length, width):
2. Declare variables N and M and initialize them to 0.
3. Draw a rectangle with sides length and width.
4. Set N←round(length/100).
5. Set M←round(width/100).
6. Draw N×M grids on that rectangle.

The SSS 420 can determine the number of photos taken by the UAV. Once the grid maker system generates the grid, it can be loaded. The Snapshot method in FIG. 5B may then followed to take the photos. Algorithm 3 and FIG. 6 can be used to calculate the number of photos to be taken.

### Algorithm 3: Procedure to Calculate the Number of Photos Taken by UAV

1. Function snapShot (N, M):
2. Declare two variables S and T and initialize them to 0.
3. Assign number of photos taken per square box of the grid to S.
4. Assign total number of photos to T.
5. Set S=12M+3.
6. Set T=NS−(2M+1).
return T

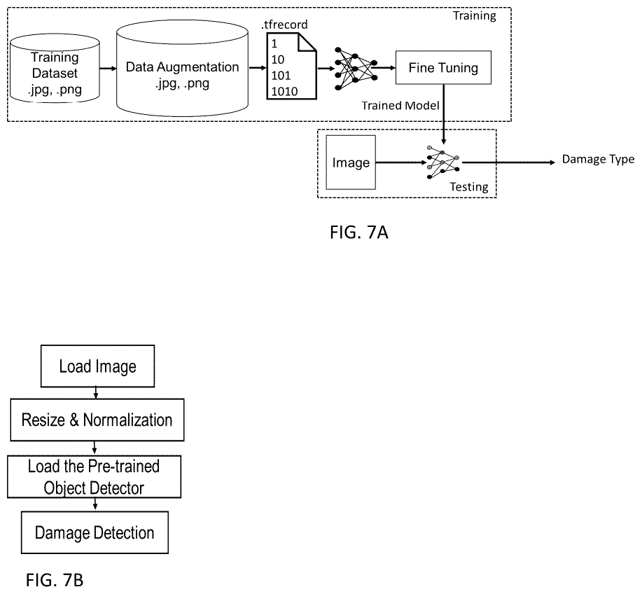

The DDS 425 can detect damage. A state-of-the-art object detector can be used to detect the damage. Any small and efficient deep learning model e.g., quantized EfficientNet B0, EfficientNet D0, and MobileNet V2/V3 maybe appropriate as feature extraction network in the object detector. The developmental workflow for an exemplary DDS is shown in FIG. 7A, and an exemplary method is shown in FIG. 7B.

The damage estimator subsystem 430 is the final system where the extent of damage is calculated. If DDS detects damage, the square in the grid is updated with 1 if not with 0. Finally, the extent of damage is calculated using:

$$Total Damage in \$ = Insured Claim Value in \$ / sq . meter \times number of damaged grid squares \times 10 , 000 \qquad ( 1 )$$

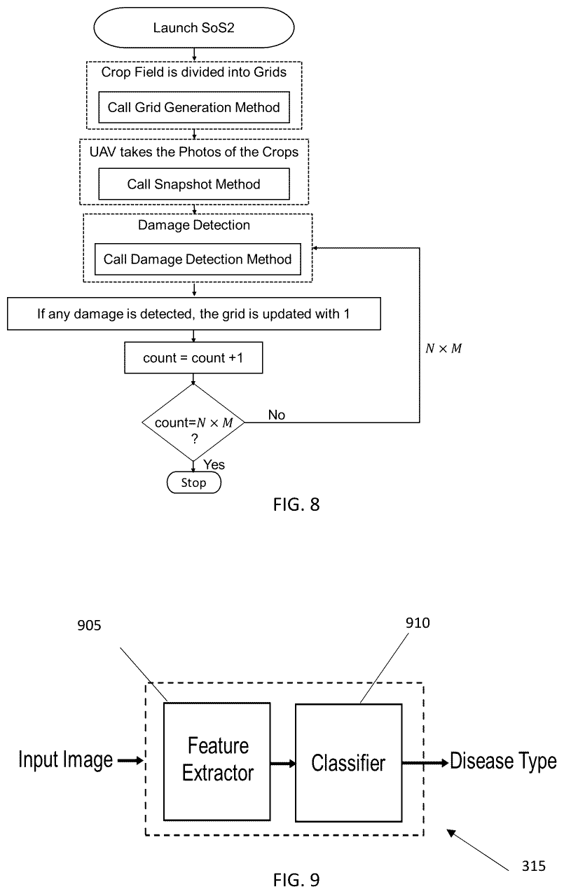

FIG. 8 illustrates an exemplary method for the extent of crop damage estimation process. In the event of crop damage due to natural causes, crop damage estimation can be performed at different times and crop growth stages for different damage types. For hail and wind damage, damage estimation can be done using the SoS2-Crop Damage Estimation System just after the disaster, whereas for heat, drought, frost, and fungal diseases, estimation can be done near to the harvest time.

A UAV can be sent to locate the latitude and longitude of the four corners of the crop field and using grid generation method in FIG. 5A, the largest grid can be drawn. Next, photos can be taken using the snapshot method in FIG. 5B and generated grid in FIG. 6. Once the photos are taken, they can be sent to the IoAT edge server. State-of-the-Art object detector may be used to detect the damage. Damage related to an individual grid can be detected using the process of FIG. 7B. For the entire grid, damage detection Algorithm 4 can be followed.

### Algorithm 4: Procedure to Detect Crop Damage for the Entire Grid

1. Function eCrop(l, w):
2. Declare variables row, column, n, m, count, damagetype, similarityscore, griddamagetype and grid and initialize them to 0.
3. Declare a variable imagecount and set the value to T from Algo. 3.
4. Draw l×w grids according to Algo. 2.
5. Set row to 0.
6. for m∈w do
7. Set column to 0
8. for n∈l do
9. for count ∈ imagecount do
10. Take photo of the crop at positions of the generated grid as in FIG. 8.
11. Detect damagetype and note similarityscore
12. Save damagetype, similarityscore, and count.
13. endfor
14. Update griddamagetype from average similarityscore.
15. Save griddamagetype and value of n and min grid.
16. column←column+100.
17. endfor
18. row←row+100.
19. endfor
20. return grid.

In embodiments, the third system of systems can be the SoS3-Plant Disease Identification System 315 (see FIG. 3A). This system can identify plant diseases from images of leaves. The model may learn to label images through supervised learning techniques and can predict the label of an unknown image. The model may learn the features of the labeled images during training and classify the unknown and unlabeled images with a confidence score. Embodiments can include two subsystems, as illustrated in FIG. 9, including the feature extractor subsystem and the classifier subsystem.

The feature extractor subsystem can comprise a convolutional neural network (CNN) in Feature Extractor 905 that can extract all the features of the input image. A custom Convolutional Neural Network (CNN), which has lesser number of parameters to train, may be developed to identify the plant disease. For example, 6,117,287 of the 6,117,991 parameters may be trainable. An exemplary CNN structure is presented in Table 1.

In the classifier subsystem, two fully connected layers may be used in the classifier system 910. The first layer can have 1280 nodes and rectified linear unit (ReLU) activation function. The second fully connected layer may have n nodes with Softmax activation, whereas n is the number of diseases needed to be identified.

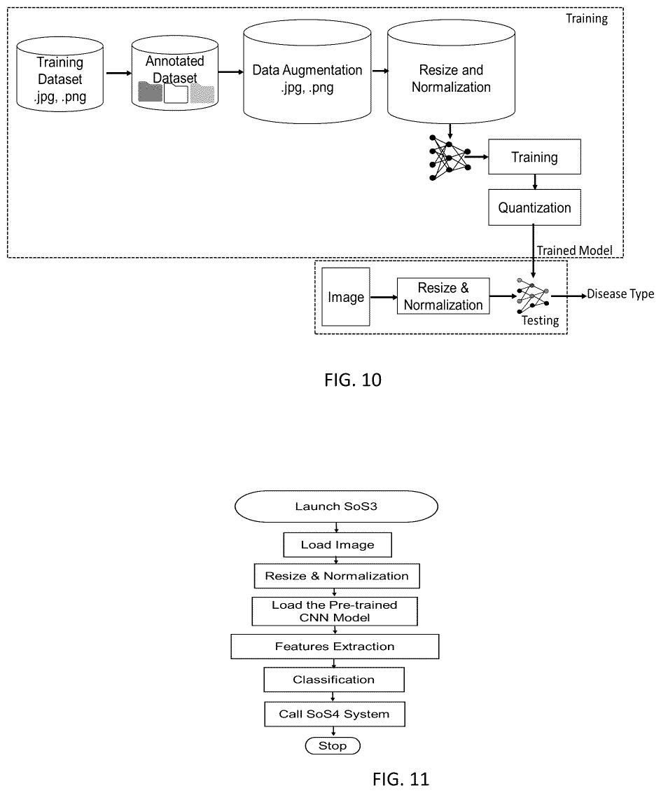

To develop this system, the system of FIG. 10 may be used. As shown the system can comprise a data store having training data. The training data can comprise a labeled data set that is labeled to form the annotated dataset. Data augmentation techniques-rotation, zoom, brightness, horizontal and vertical flip—may be used to generate augmented data that can then be formatted to resize and normalize the images. In some aspects, an Adam optimizer can be used. Post training float16 quantization may be used to optimize the model. The model can be trained with a public dataset.

FIG. 11 shows an exemplary SoS3-Plant Disease Detection System Process, of the sort that can be used in the plant disease identification system 315. First the photo can be taken, and image preprocessing can be done in the image preprocessing subsystem of the utility system. Then the feature extractor can extract the features and classifier can identify the disease from the features. Next, the system SoS4, 320 discussed herein, can be called. SoS4 (system 4, which is shown as 320 in FIG. 3a) can estimate the severity of the disease. Typically, SoS4 is a dependent system of SoS3 and may not be called independently.

TABLE 1
Exemplary CNN Structure for SoS3

| Layers | Output Shape |
|---|---|
| Conv2D (f = 32, k = 3, s = 1, p = 0) | (254, 254, 32) |
| Activation: ReLU | (254, 254, 32) |
| BatchNormalization | (254, 254, 32) |
| Maxpooling2D (k = 2, s = 2) | (127, 127, 3) |
| Conv2D (f = 64, k = 3, s = 1, p = 0) | (125, 125, 64) |
| Activation: ReLU | (125, 125, 64) |
| BatchNormalization | (125, 125, 64) |
| Maxpooling2D (k = 2, s = 2) | (62, 62, 64) |
| Conv2D (f = 64, k = 3, s = 1, p = 0) | (60, 60, 64) |
| Activation: ReLU | (60, 60, 64) |
| BatchNormalization | (60, 60, 64) |
| Maxpooling2D (k = 2, s = 2) | (30, 30, 64) |
| Conv2D (f = 64, k = 3, s = 1, p = 0) | (28, 28, 64) |
| Activation: ReLU | (28, 28, 64) |
| BatchNormalization | (28, 28, 64) |
| Maxpooling2D (k = 2, s = 2) | (14, 14, 64) |
| Conv2D (f = 128, k = 3, s = 1, p = 0) | (12, 12, 128) |
| Activation: ReLU | (12, 12, 128) |
| BatchNormalization | (12, 12, 128) |
| Maxpooling2D (k = 2, s = 2) | (6, 6, 128) |
| Flatten | (4, 608) |
| Dense (u = 1280) | (1280,) |
| Dense (u = 39) | (39,) |

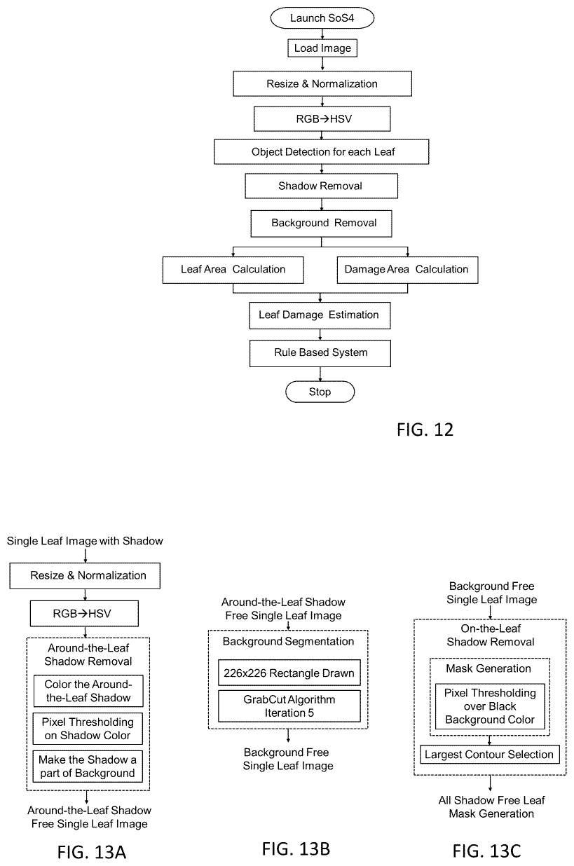

In some embodiments, the fourth system of systems can be the severity of the plant disease estimation system 320 (see FIG. 3A). For example, system SoS4 (320) can estimate the severity of the disease. FIG. 12 illustrates an exemplary process. Once system SoS3 calls the system SoS4, the system SoS3 can pass the image to SoS4. Image preprocessing subsystem in the utility system can resize and normalize the images and change the color space from RGB to HSV. If there are several leaves present in the image, each leaf can be detected, for example using a state-of-the art object detector. Exemplary subsystems can include a leaf area detection subsystem, a damage area detection subsystem, and/or a leaf damage estimation subsystem.

The leaf area detection subsystem can be used to detect and identify leaves in the images. A leaf can contain two types of shadows including around-the-leaf and on-the-leaf. For each leaf, around-the-leaf shadow removal can be performed, for example following the process illustrated in FIG. 13A, and once the around the leaf shadow is removed, the background of the leaf can also be removed, for example following the process illustrated in FIG. 13B. Finally, the leaf mask can be generated, for example following the process illustrated in FIG. 13C. On-the-leaf shadows can be removed from selecting the largest contour in generating leaf mask. From the created leaf mask, the number of pixels in the mask can be counted and area of the leaf can be measured.

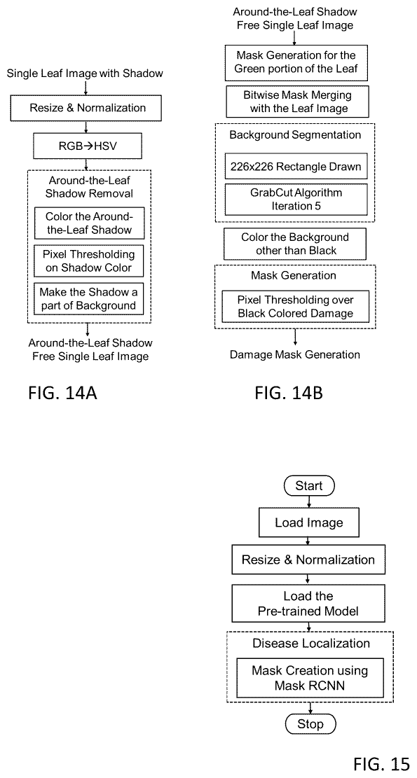

The system can also include a damage area detection system. FIG. 14 illustrates an exemplary process of damage area detection. For each leaf, around-the-leaf shadow can be removed, for example as illustrated in FIG. 14A. This part can be common for both leaf and damage area detection. The output from FIG. 14A can be used as the input of FIG. 14B. Damage mask can be generated, for example as illustrated by the process in FIG. 14B. Here, the mask can be created for the green portion of the leaf and merged bitwise with the leaf image. To differentiate the damage from the background the segmented background can be colored with color other than the black. Finally, the mask for the damage can be created by pixel thresholding on black color. From the created damage mask, the number of pixels in the mask can be counted and the area of the damage parts can be measured.

The system can also comprise a leaf damage estimation subsystem. For estimating leaf damage, a rule-based system can be used. A ratio can be taken between the leaf area and the damage area, and a percentage value of that ratio can be used to decide the severity of the damage, for example from a grade scale such as is provided in Table.2.

TABLE 2
Exemplary Damage Severity Grade Scale

| Estimated Damage (%) | Damage Severity Grade |
|---|---|
| 0 | Healthy |
| >0 and <=5 | 1 |
| >5 and <=10 | 2 |
| >10 and <=25 | 3 |
| >25 and <=50 | 4 |
| >50 | 5 |

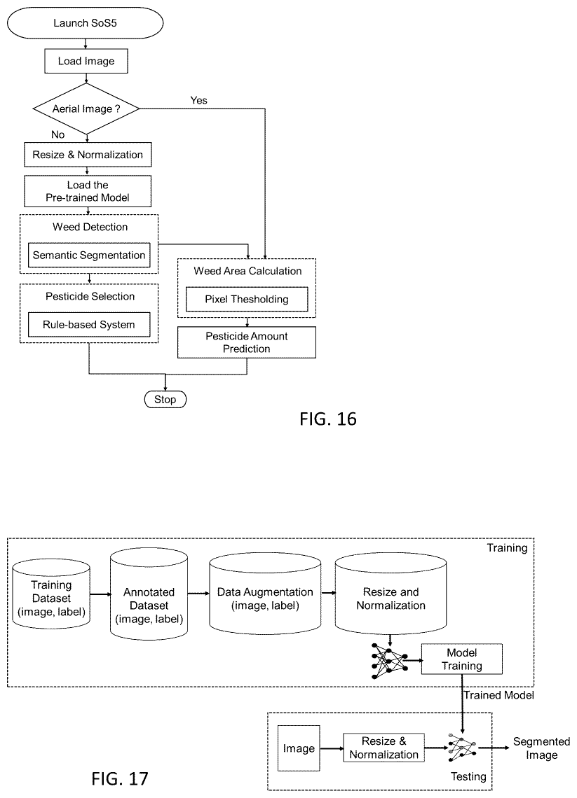

The work can be verified with automated estimation of the damaged area by creating masks for the damaged areas and the leaf area. Finally, the ratio of these two can decide the grade of severity of the disease. To create the ground truth mask, image annotation creating the mask can be generated, for example with an image annotation tool. Some embodiments may use polygon annotation to create mask with the exact shape of the damage and leaf. FIG. 15 illustrates an exemplary workflow of such a process. In embodiments, the model can be trained with a public dataset. Alternatively, a data set can be obtained over time and used to train the model. In embodiments, the fifth system of systems can be the weed identification system 325 (see FIG. 3a). System SoS5 325 can identify the weeds from the image and predict pesticide. FIG. 16 illustrates an exemplary weed identification system process. If an aerial image is taken through a UAV camera, pesticide amount can also be calculated. The image can be loaded and preprocessed through the utility system. Semantic segmentation can be used to identify the weed, and weed can be segmented. Appropriate pesticide can be selected (e.g. based on the identified weed) according to a rule-based algorithm, for example as in Algorithm 5.

### Algorithm 5: Procedure to Select Pesticide

1. Function pestSelect (H, plantdisease):
2. Initialize a hash table H with key names of plant disease names (d1, d2, d3, d4, . . . ) and values of pesticide names (p1, p2, p3, p4 . . . ) as p1=H (d1), p2=H (d2) etc.
3. Declare variables x, y and pesticide and assign values of 0 to them.
4. for x∈plantdiseasenames do
5. if x==plantdisease
6. y=H[plantdisease]
7. Set y to pesticide.
8. endif
9. endfor
10. return pesticide
   If the image is UAV taken, then the total weed infested area can be calculated using pixel thresholding method. Finally, the pesticide amount can be calculated, for example using Algorithm 6. FIG. 17 illustrates an exemplary workflow to develop the system.

### Algorithm 6: Procedure to Select Pesticide Amount

1. Function pestamountSelect (testpesticide, area):
2. Initialize a hash table H with key names of pesticide names (p1, p2, p3, p4 . . . ) and values of pesticide's amount per square unit (a1, a2, a3, a4, . . . ) as a1=H(p1), a2=H(p2) etc.
3. Declare a variable p, y, and testpesticideamount and assign values of 0.
4. for p∈pesticidenames do
5. if p==testpesticide
6. Find the corresponding pesticide amount per square unit area y=H[p].
7. Calculate testpesticideamount=area×y.
8. endif
9. endfor
10. return testpesticideamount

While some system embodiments, such as that shown in FIGS. 3A-3B may include systems and/or subsystems for crop damage estimation, plant disease identification, plant disease severity evaluation, and weed identification (for example, in addition to a utility system), in other systems less than all such systems or subsystems may be used. For example, disclosed embodiments may include one or more of the following: crop damage estimation, plant disease identification, plant disease severity evaluation, and/or weed identification. Typically, systems having plant disease identification will also include plant disease severity estimation.

Some disclosed embodiments may operate automatically and/or in real time. In some embodiments, the technology used to implement the system may be of the type available to even smallholder farmers in remote villages. For example, using smartphone technology may allow for effective operation even in more remote farming areas. By effectively providing valuable crop analysis service to a wide variety of farmers (e.g. from large corporate farms to small, individualized farms), the effectiveness of the system and its impact on crop issues can be maximized. The system can be configured to be used without expert assistance, for example allowing real-time detection of plant disease even for those farmers without access to expert services. The system can provide automated detection and/or guidance for one or more crop issue, so that actions can be taken in a timely manner. For example, guidance may be provided to a user on an output device (such as a screen or a smartphone), in response to a determination of damage, disease, and/or weeds with respect to the crops in the crop area providing the input to the system, and action may be taken by the user or automatically based on the guidance. In some embodiments, the system can be accessed through a mobile interface (e.g. such as a smart phone).

In some exemplary embodiments, an automated real time approach for plant disease detection can be used. For example, object detection can include a computer vision technique that is used for counting objects, tracking object location, and/or accurately identifying objects in an image or video frame. In some embodiments, to identify plant disease in real time, an efficient, fast, small-sized deep learning model may be used. For example, one or more state-of-the-art object detectors, such as “You Only Look Once” models like YOLOv8 and YOLOv5, can be used to detect and localize the plant diseases.

If any plants are infected with diseases, farmers can capture images of the infected leaves, for example using a mobile interface on a smart phone. The system can then predict the disease. In some embodiments, the object detector-based detection method may detect the disease from the full image in only one evaluation and with only one forward pass. The network can break the image into regions/grids and predict bounding boxes and probabilities for each region. The predicted probabilities can be used to give these boxes weights. Such a process can be very fast and may not need a complex operational pipeline. Hence, it can be suitable for real time disease detection of large crop fields. The small size and high efficiency of the models can make them suitable for implementation in edge computing hardware. Embodiments may allow for scaling for any type of crop field.

Some model embodiments may connect class labels with bounding boxes in an end-to-end differentiable network. For example, a single CNN can predict bounding boxes with class probabilities. Exemplary models may have three primary components including a backbone, a neck, and a head.

The backbone module can extract and exploit features of different resolutions from an input image. By way of example, CSP-Darknet53 can serve as the backbone for YOLOv5. CSP stands for Cross Stage Partial, and can extract the features from the image. The neck can fuse the features from the difference resolutions extracted by the backbone. In some aspects, the neck module can use a variant of Spatial Pyramid Pooling (SPP). It can help the network to perform accurately on unseen data. The Path Aggregation Network (PANet) can be modified by including the BottleNeckCSP in its architecture. The head module or modules can perform the detection of objects using the different resolutions. The head module(s) can use neck features for box and class prediction. The same head as YOLOv3 and YOLOv4 can be used by YOLOv5. It may be made up of three convolution layers that predict where the bounding boxes (x, y, height, and width), objectness scores, and object classes will be.

The following equations can be used to calculate the target bounding boxes, for example in YOLOv5:

bₓ=(2·σ(tₓ)−0.5)+cₓ

b_{y}=(2·σ(t_{y})−0.5)+c_{y}

b_{w}=p_{w}·(2·σ(t_{w}))²v

bₕ=pₕ·(2·σ(tₕ))²

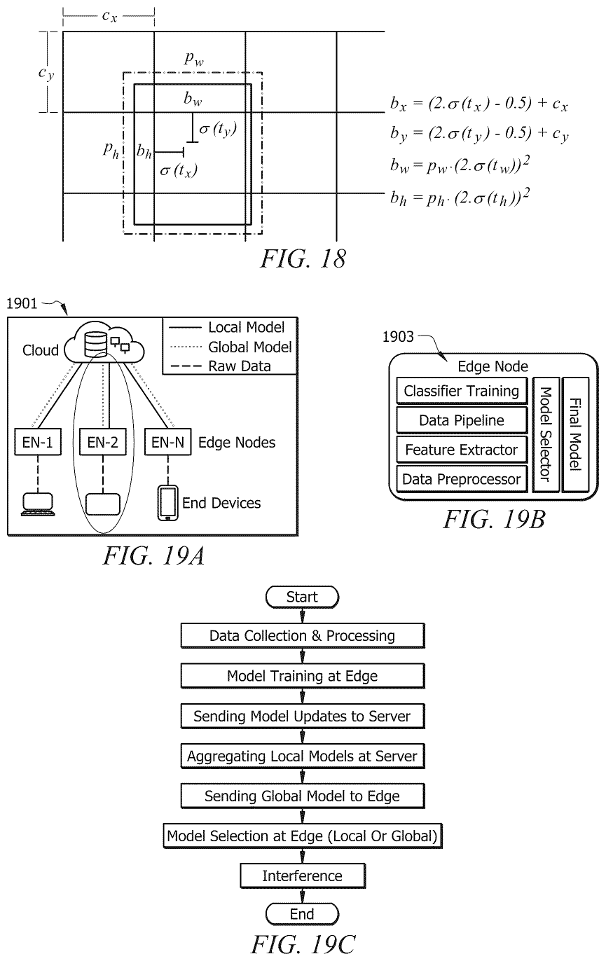

FIG. 18 shows the terms appearing in these equations. bₓ, b_{y}, b_{w}, bₕ are the center, width, and height of the predicted bounding box, tₓ, t_{y}, t_{w}, and tₕ are the outputs of the neural networks, cₓ and c_{y} are the cell's top left corner of the anchor box, and p_{w} and pₕ are the anchor's width and height.

Binary Cross Entropy loss can be used to calculate class loss and objectness loss whereas complete intersection over union loss can be used to calculate location loss. Logistic regression can be used to predict the confidence score of each box. Hence, each box can predict the class type associated with the bounding box using multilevel classification.

When the network sees a leaf for the disease detection, the image can be divided into S×S grids. The grid cell contributes in detecting when the center of the object falls on that grid. For each grid cell, bounding boxes and confidence scores can be predicted. No object means zero confidence score. The intersection over union of the predicted bounding box and the ground truth bounding box can calculate the confidence scores.

Some model embodiments can be used for instance segmentation along with classification and object detection, and may be anchor-free in nature. It may be able to directly predict the center of an object rather than the offset from a known prior or anchor box. As a result, the number of box predictions may be reduced and the overall system can become faster by speeding up the non-maximum suppression. Architecture-wise there can be certain modifications, such as: the earlier C2f module can be replaced by the C3 module, the first 3×3 conv in the bottleneck can be changed to 6×6, and the first 1×1 conv in the bottleneck can be replaced by 3×3. Without mandating channel dimensions, neck features may be fused directly.

Data augmentation may play a significant role in model training. One of these is mosaic augmentation. This can be done by putting together four images, which forces the model to learn how to recognize objects in new places, with partial occlusion, and against different pixels around them. Some embodiments may use image augmentation techniques for model training. For example, HSV adjustment, translation, scaling, left to right flip, and mosaic augmentation can be used. For better performance, mosaic augmentation may be turned off for the last ten epochs. The data augmentation parameters can be kept as default: Blur parameter p can be set to 0.01 and blur limit to (3, 7), MedianBlur parameter p to 0.01 and blur limit to (3, 7), ToGray to 0.01, CLAHE parameter p to 0.01 and clip limit to (1, 4.0), tile grid size to (8, 8).

Another possibly important stage in object detector training can be the annotation of images with ground truth. In the training datasets, bounding boxes may be drawn across the objects. For example, MakeSense.AI, an open source image annotation tool, may be used to annotate the data, and the Rect tool may be utilized to annotate images. Annotation files can be saved in “.xml” format and provide the coordinates of the bounding box's two diagonally placed corners. Different colors can be used for different classes when labeling.

When training a model, PyTorch may be used as the deep learning framework. For example, the models may be trained for 100 epochs (e.g. YOLOv8) and 150 epochs (e.g. YOLOv5). A stochastic gradient decent optimizer with a default learning rate of 0.01 can be used. Batch sizes may be kept at 32 for YOLOv8 and at 16 for YOLOv5.

Some embodiments may use Federated Learning (FL) as a computing strategy to train a Machine Learning (ML) or Deep Learning (DL) model in a decentralized manner, instead of training a centralized model on a server. This can help to overcome data regulation and privacy aspects, as well as unreliable and low-bandwidth internet connections. Clients, such as mobile phones, personal computers, tablets, and application-specific Internet of Things (IoT) devices, can act as decentralized training nodes and actively participate in training with the local data. Once the training is complete, these nodes can send the local model updates to the server. All the updates can then be aggregated to generate a global model in the server. (e.g. which may then be used by one or more user, for example via mobile interface). In embodiments, the updated models can be accessed via Wi-Fi in the field and/or can be downloaded to a smart phone or other such device for use even when there is no connectivity.

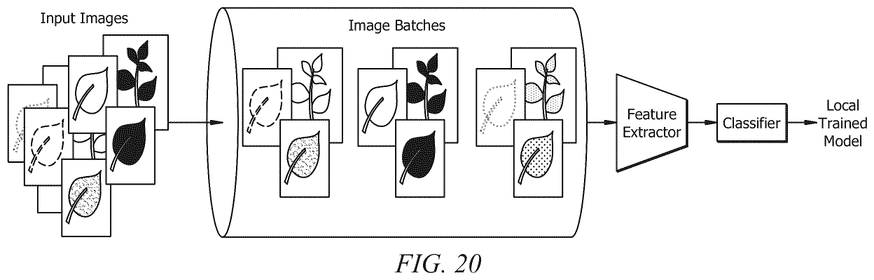

Algorithm 7 below can provide an exemplary incremental training protocol for a model, which can allow the resource-constrained edge nodes of an FL system to handle data processing, model training, model selection, and inference. When images are available to a node, unsupervised learning can allow adding new and unknown classes. A high-level overview of an exemplary FL network 1901 is provided in FIG. 19A. It has three levels: end device, edge, and cloud server. FIG. 19B illustrates exemplary modules in an edge node 1903. FIG. 19C illustrates exemplary steps: data collection, processing, edge model training, server updates, local model aggregation, global model transmission, edge model selection, and inference. FIG. 20 illustrates an exemplary workflow of training the local model in an edge node.

### Algorithm 7:

1: Input: Image I
2: Output: Prediction P
3: Random weights w₀ are initialized to the global model in the Server;
4: w₀ is sent to all the edge nodes N of the FL network;
5: for n∈N do/* Training for all the nodes. */
6: Set a list for the metric and initialize its value to a empty list;
7: counter=0;
8: Set a batch size;
9: while image≠None do/* When images are available to a node. */
10: Make image batches B.
11: for β∈B do
12: Extract feature vectors F from β using the feature extractor module;
13: Flatten F for β;
14: Save F;
15: for f∈F do
16: Send f to the classifier pipeline;
17: Predict P for f;
18: Update the weights;
19: end for
20: Delete F
21: end for
22: Save metric;
23: counter+=1;
24: end while
25: if metric_{counter}≥metric_{counter-1} then
26: Send the local model Mₗ to the server;
27: Server aggregates the model as per [24];
28: Server sends the global model M_{g} to n;
29: end if
30: if metric_{local}»metric_{global} then
31: Keep the Mₗ;
32: else
33: Keep the M_{g};
34: end if
35: Use the trained model M to predict the unknown image imageunknown;
36: end for

In some embodiments, the disease classification network can include two parts-feature extractor and classifier. The feature extractor can be configured to extract the features from the images, and the classifier can be configured to classify the images based on the feature vectors. However, loading all the extracted feature vectors in a data frame may be too large to fit into the memory of an edge device.

The training protocol may address this issue. First, transfer learning may allow for faster training and higher accuracy. By way of example, MobileNetV2 pre-trained on ImageNet dataset can be used as the feature extractor, and feature vectors can be obtained from a pre-specified layer. The feature vectors from the input images can be extracted batch-wise to save in a .csv file. Accessing all the feature vectors at once by loading them to memory can stall the training. Hence, the classifier can be trained with the feature vectors of images one by one using Algorithm.1. The classifier can be encapsulated in a pipeline. Standardization of the feature vectors can first be performed in the pipeline to get a standardized distribution with a 0 mean and unit variance.

Additionally, logistic regression can be used as the final classifier layer to map standardized feature vectors to class labels. For example, OneVsRest can be used with linear regression to accommodate multiple classes. So, the multi-class classification problem can be trained as separate M binary class problems where each classifier fm is trained to determine whether the feature vector belongs to a class m or not where m∈{1, 2, . . . , M}. For a test example c, all M classifiers are run for c, and the highest score is selected. As the optimizer stochastic gradient descent (SGD) (with learning rate 0.01) and loss function log loss have been used. The classifier can also be trained in an unsupervised way so that future unknown classes can be classified.

The trained models may be used by an end user via a mobile interface. In an example, the mobile interface may be developed in Android Studio IDE using JAVA. The Nexus 5 API 30 emulator can be used to emulate the application. The mobile interface may include a photo button and a detect button. Using the “PHOTO” button, the user can take a picture of the plant leaf. Once the photo is captured, the “DETECT” button can allow the user to show the result (e.g. based on the automated system for detecting plant disease). A video option may also be available in some embodiments (e.g. either still images or video images may be used).

In some embodiments, image data relating to the crop area may be provided by smart phone, for example providing either still images or video, and/or by UAV (such as one or more drone), which may provide still and/or video images. In some embodiments, the data may be processed individually (e.g. relating only to the particular crop area) and/or by the smartphone, while in other embodiments, any data from surrounding crop areas (e.g. crop areas within a region including the crop area of interest) may also be factored in when evaluating issues (for example with the idea that adjacent crop areas may be plagued by similar issues, such that cumulating data from surrounding/adjacent areas may provide better evaluation as a whole) and/or data may be processed at a centralized site (e.g. within the cloud) rather than at point-specific sites.

Particular system details, such as models, model training and mobile interface, are merely exemplary, and persons of skill will appreciate that any technical elements configured to implement the system embodiments described herein are included within the scope of this disclosure.

Disclosed herein are various aspects for methods, systems, processes, and algorithms including, but not limited to:

In a first aspect, a crop monitoring system comprises: a memory comprising a crop monitoring application; and a processor, wherein the crop monitoring application, when executed on the processor, configures the processor to: receive one or more images of a crop area; process the image to generate processed image data; input the processed image data into one or more crop models; and identify one or more properties of a crop based on an output from the one or more crop models.

A second aspect can include the system of the first aspect, where the images are of plants.

A third aspect can include the system of the first or second aspects, wherein processing the image comprises sizing the image, normalizing the image, and/or setting a color flag for the image.

A fourth aspect can include the system of any one of the first to third aspects, wherein the models comprise a crop damage estimation model, a plant disease identification model, a plant disease severity estimation model, and/or a weed identification model.

A fifth aspect can include the system of any one of the first to fourth aspects, further comprising: training one or more of the models.

A sixth aspect can include the system of any one of the first to fifth aspects, wherein the processor is further configured to: receive location information comprising a boundary of a crop area; calculate a distance along the boundary; generate a grid for the crop area; and initiate the image collection of the one or more images along a pattern within the grid.

A seventh aspect can include the system of any one of the first to sixth aspects, wherein the processor is further configured to: extract one or more features from an image of the one or more images of the crop area; use the one or more features in a disease classifier model; and identify one or more plant diseases associated with the image based on an output of the disease classifier model.

An eighth aspect can include the system of any one of the first to seventh aspects, wherein the processor is further configured to: extract an image of a leaf in the image; determine an area of the leaf; determine an area of damage on the leaf; and determine a severity of a disease using the area of the leaf and the area of damage on the leaf.

A ninth aspect can include the system of any one of the first to eighth aspects, wherein the processor is further configured to: extract an image of a plant in the image; determine type of plant from the image of the plant; and determine a type of pesticide for treating the cop area based on the type of plant.

In a tenth aspect, a crop monitoring method comprises: receiving, by at least one processor, one or more images of a crop area; processing the image to generate processed image data; inputting the processed image data into one or more crop models; and identifying one or more properties of a crop based on an output from the one or more crop models.

An eleventh aspect can include the method of the tenth aspect, wherein the images are of plants.

A twelfth aspect can include the method of any one of the tenth to eleventh aspects, wherein processing the image comprises sizing the image, normalizing the image, and/or setting a color flag for the image.

A thirteenth aspect can include the method of any one of the tenth to twelfth aspects, wherein the models comprise: a crop damage estimation model, a plant disease identification model, a plant disease severity estimation model, and/or a weed identification model.

A fourteenth aspect can include the method of any one of the tenth to thirteenth aspects, further comprising: training one or more of the models.

A fifteenth aspect can include the method of any one of the tenth to fourteenth aspects, further comprising: receiving location information comprising a boundary of a crop area; calculating a distance along the boundary; generating a grid for the crop area; and initiating the image collection of the one or more images along a pattern within the grid.

A sixteenth aspect can include the method of any one of the tenth to fifteenth aspects, further comprising: extracting one or more features from an image of the one or more images of the crop area; using the one or more features in a disease classifier model; and identifying one or more plant diseases associated with the image based on an output of the disease classifier model.

A seventeenth aspect can include the method of any one of the tenth to sixteenth aspects, further comprising: extracting an image of a leaf in the image; determining an area of the leaf; determining an area of damage on the leaf; and determining a severity of a disease using the area of the leaf and the area of damage on the leaf.

An eighteenth aspect can include the method of any one of the tenth to seventeenth aspects, further comprising: extracting an image of a plant in the image; determining type of plant from the image of the plant; and determining a type of pesticide for treating the cop area based on the type of plant.

A nineteenth aspect can include the method of any one of the tenth to eighteenth aspects, further comprising taking action on the crop area based on the identified one or more properties of the crop.

A twentieth aspect can include the method of any one of the tenth to nineteenth aspects, further comprising providing to the at least one processor one or more images of the crop area (e.g. from one or more camera, which may include smart phone devices and/or UAVs).

A twenty-first aspect can include the method of any one of the tenth to twentieth aspects, using the system of any one of the first to ninth aspects.

While aspects have been shown and described, modifications thereof can be made by one skilled in the art without departing from the spirit and teachings of this disclosure. The aspects described herein are exemplary only, and are not intended to be limiting. Many variations and modifications of the aspects disclosed herein are possible and are within the scope of this disclosure. For example, the various elements or components may be combined or integrated in another system or certain features may be omitted or not implemented. Also, techniques, systems, subsystems, and methods described and illustrated in the various aspects as discrete or separate may be combined or integrated with other techniques, systems, subsystems, or methods without departing from the scope of this disclosure. Other items shown or discussed as directly coupled or connected or communicating with each other may be indirectly coupled, connected, or communicated with. Method or process steps set forth may be performed in a different order. The use of terms, such as “first,” “second,” “third” or “fourth” to describe various processes or structures is only used as a shorthand reference to such steps/structures and does not necessarily imply that such steps/structures are performed/formed in that ordered sequence (unless such requirement is clearly stated explicitly in the specification).

Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru-Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, 95 percent, 96 percent, 97 percent, 98 percent, 99 percent, or 100 percent. Moreover, any numerical range defined by two R numbers as defined in the above is also specifically disclosed. Language of degree used herein, such as “approximately,” “about,” “generally,” and “substantially,” represent a value, amount, or characteristic close to the stated value, amount, or characteristic that still performs a desired function or achieves a desired result. For example, the language of degree may mean a range of values as understood by a person of skill or, otherwise, an amount that is +/−10%.

Use of broader terms such as comprises, includes, having, etc. should be understood to provide support for narrower terms such as consisting of, consisting essentially of, comprised substantially of, etc. When a feature is described as “optional,” both aspects with this feature and aspects without this feature are disclosed. Similarly, the present disclosure contemplates aspects where this “optional” feature is required and aspects where this feature is specifically excluded. The use of the terms such as “high-pressure” and “low-pressure” is intended to only be descriptive of the component and their position within the systems disclosed herein. That is, the use of such terms should not be understood to imply that there is a specific operating pressure or pressure rating for such components. For example, the term “high-pressure” describing a manifold should be understood to refer to a manifold that receives pressurized fluid that has been discharged from a pump irrespective of the actual pressure of the fluid as it leaves the pump or enters the manifold. Similarly, the term “low-pressure” describing a manifold should be understood to refer to a manifold that receives fluid and supplies that fluid to the suction side of the pump irrespective of the actual pressure of the fluid within the low-pressure manifold.

Accordingly, the scope of protection is not limited by the description set out above but is only limited by the claims which follow, that scope including all equivalents of the subject matter of the claims. Each and every claim is incorporated into the specification as aspects of the present disclosure. Thus, the claims are a further description and are an addition to the aspects of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

As used herein, the term “and/or” includes any combination of the elements associated with the “and/or” term. Thus, the phrase “A, B, and/or C” includes any of A alone, B alone, C alone, A and B together, B and C together, A and C together, or A, B, and C together.

What is claimed is:

1. A crop monitoring system comprising:
a memory comprising a crop monitoring application; and
a processor,
wherein the crop monitoring application, when executed on the processor, configures the processor to:
receive one or more images of a crop area;
process the image to generate processed image data;
input the processed image data into one or more crop models; and
identify one or more properties of a crop based on an output from the one or more crop models.

2. The system of claim 1, where the images are of plants.

3. The system of claim 1, wherein processing the image comprises at least one selected from the following: sizing the image, normalizing the image, and setting a color flag for the image.

4. The system of any one of claim 1, wherein the one or more crop models comprise at least one selected from the following: a crop damage estimation model, a plant disease identification model, a plant disease severity estimation model, and a weed identification model.

5. The system of any one of claim 4, further comprising: training the one or more models.

6. The system of claim 1, where the processor is further configured to:
receive location information comprising a boundary of a crop area;
calculate a distance along the boundary;
generate a grid for the crop area; and
initiate the image collection of the one or more images along a pattern within the grid.

7. The system of claim 1, where the processor is further configured to:
extract one or more features from an image of the one or more images of the crop area;
use the one or more features in a disease classifier model; and
identify one or more plant diseases associated with the image based on an output of the disease classifier model.

8. The system of claim 7, where the processor is further configured to:
extract an image of a leaf in the image;
determine an area of the leaf;
determine an area of damage on the leaf; and
determine a severity of a disease using the area of the leaf and the area of damage on the leaf.

9. The system of any one of claim 1, where the processor is further configured to:
extract an image of a plant in the image;
determine type of plant from the image of the plant;
determine a type of pesticide for treating the crop area based on the type of plant.

10. A crop monitoring method comprising:
receiving, by at least one processor, one or more images of a crop area;
processing the one or more images to generate processed image data;
inputting the processed image data into one or more crop models; and
identifying one or more properties of a crop based on an output from the one or more crop models.

11. The method of claim 10, where the images are of plants.

12. The method of claim 10, wherein processing the one or more imaged comprises at least one selected from the following: sizing the image, normalizing the image, setting a color flag for the image.

13. The method of any one of claim 10, wherein the one or more crop models comprise at least one selected from the following: a crop damage estimation model, a plant disease identification model, a plant disease severity estimation model, and a weed identification model.

14. The method of any one of claim 13, further comprising: training one or more of the models.

15. The method of claim 10, further comprising:
receiving location information comprising a boundary of a crop area;
calculating a distance along the boundary;
generating a grid for the crop area; and
initiating the image collection of the one or more images along a pattern within the grid.

16. The method of claim 10, further comprising:
extracting one or more features from an image of the one or more images of the crop area;
using the one or more features in a disease classifier model; and
identifying one or more plant diseases associated with the image based on an output of the disease classifier model.

17. The method of claim 16, further comprising:
extracting an image of a leaf in the image;
determining an area of the leaf;
determining an area of damage on the leaf; and
determining a severity of a disease using the area of the leaf and the area of damage on the leaf.

18. The method of claim 10, further comprising:
extracting an image of a plant in the image;
determining type of plant from the image of the plant; and
determining a type of pesticide for treating the cop area based on the type of plant.

19. The method of claim 10, further comprising taking action on the crop area based on the identified one or more properties of the crop.

20. The method of claim 10, further comprising providing to the at least one processor one or more images of the crop area from one or more camera.
